(19) United States
(12) Patent Application Publication
(10) Pub. No.: US 2025/0349045 A1
(43) Pub. Date: Nov. 13, 2025

(54) GENERATING A CONSISTENT STYLE OUTPUT FROM INPUTS WITH DIFFERENT STYLES

(71) Applicant: Apple Inc., Cupertino, CA (US)

(72) Inventors: Thomas Deselaers, Zurich (CH); Ryan S. Dixon, Redwood City, CA (US); Olga Barinova, Cupertino, CA (US); Jun Hatori, Cupertino, CA (US); Come Weber, Zurich (CH)

(21) Appl. No.: 18/956,832

(22) Filed: Nov. 22, 2024

Related U.S. Application Data
(60) Provisional application No. 63/646,345, filed on May 13, 2024.

(51) Int. Cl. G06T 11/00; G06N 3/0475; G06T 11/40

(52) U.S. Cl. CPC G06T 11/001; G06N 3/0475; G06T 11/40

(57) ABSTRACT

The present technology attempts to provide a generative AI service to run locally on a computing device where the generative AI service can receive a rough sketch input as a prompt and generate a higher-quality output. The present technology utilizes a common generative AI service for a variety of use cases and supplements the common generative AI service with a variety of graphical style adapters. The graphical style adapters are also configured to receive sketches as inputs and condition them for use by the generative AI service. Some conditioning of sketches can include determining a sketch complexity metric and taking steps to acknowledge that sketches might be an outline of any object without much fill coloring but that the outline might not reflect the intention of the user that a sketched object is to be created with or without fill and texture.

### CROSS-REFERENCE TO RELATED APPLICATIONS

This application claims the benefit of priority to U.S. provisional application No. 63/646,345, filed on May 13, 2024, which is expressly incorporated by reference herein in its entirety.

### BACKGROUND

Tools that bridge the gap between human creativity and artificial intelligence (AI) capabilities are popular. Users, ranging from professional designers and artists to hobbyists, can use generative AI service technologies to receive visual input and transform it into a desired output.

### BRIEF DESCRIPTION OF THE SEVERAL VIEWS OF THE DRAWINGS

Details of one or more embodiments of the subject matter described in this disclosure are set forth in the accompanying drawings and the description below. However, the accompanying drawings illustrate only some typical embodiments of this disclosure and are therefore not to be considered limiting of its scope. Other features, embodiments, and advantages will become apparent from the description, the drawings and the claims.

FIG. 1 illustrates an example system in accordance with some embodiments of the present technology.

FIG. 2A and FIG. 2B illustrates a more detailed example of an application, graphical style adapter, and generative AI service in accordance with some embodiments of the present technology.

FIG. 3A and FIG. 3B illustrates an example routine for generating a stylized image from a graphical input in accordance with some embodiments of the present technology.

FIG. 4 illustrates a high-level system diagram providing an example of a sketch graphical input and transformations of the sketch graphical input to result in the output stylized image in accordance with some embodiments of the present technology.

FIG. 5 illustrates a high-level system diagram providing an example of a sketch graphical input and a non-sketch portion of the graphical input and transformations of the graphical inputs to result in the output stylized image in accordance with some embodiments of the present technology.

FIG. 6 illustrates a high-level system diagram providing an example of a sketch graphical input and a non-sketch portion of the graphical input and transformations of the graphical inputs to result in a portion of the output stylized image overlaid the input non-sketch portion of the graphical input in accordance with some embodiments of the present technology.

FIG. 7 illustrates an example routine for receiving an input in a first style and providing an output as a stylized image in a style that is different than the first style in accordance with some embodiments of the present technology.

FIG. 8 is a system diagram illustrating a device in accordance with some embodiments of the present technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Tools that bridge the gap between human creativity and artificial intelligence (AI) capabilities are popular. Users, ranging from professional designers and artists to hobbyists, can use generative AI service technologies to receive a visual input and transform the visual input into a desired output. Despite the impressive capabilities of such tools, generative AI service technologies still have room for much improvement.

For example, many generative AI service technologies are large in size and require a large amount of memory and processing power to run, but this often requires sending prompts over the Internet to data centers. Some prompts contain private information, and this sometimes prevents privacy-conscious people from using generative AI service with private information. One type of information that is often privacy-sensitive is images, especially photos.

The present technology attempts to provide generative AI service to run locally on a computing device. However, achieving this aim is not as straightforward as it might seem. While a naïve approach might involve training a generative AI service technology with a model size that is small enough to run locally, it is difficult to achieve sufficient quality across a spectrum of expected use cases. The present technology utilizes a common generative AI service for a variety of use cases and supplements the common generative AI service with a variety of graphical style adapters. This architecture provides the required quality while allowing the size of the common generative AI service to be small enough to run locally-even on a mobile computing device. Even with this architecture, other optimizations are used. For example, to conserve available memory, different portions of a pipeline of services used in combination with the common generative AI service can be brought in and out of memory as needed.

In another example, while generative AI service technologies can work with visual input and modify it based on a natural language prompt, such tools are not consistent at delivering on the intent of the user.

One type of visual input that can be difficult for generative AI service to interpret well enough to generate a satisfactory output is hand-drawn sketches. Hand-drawn sketches can be difficult to input because different users have different abilities, and even a skilled user might make a quick sketch in one instance and a detailed sketch in another instance. Thus, properly interpreting an input sketch so that a generative AI service can provide proper attention to attributes of a sketch in some instances while understanding the sketch as higher-level guidance to convey a concept in other instances is important to generating a satisfactory output.

The present technology addresses this shortcoming of generative AI service through several innovations. For example, the present technology determines a sketch complexity metric as a proxy to convey how much effort a user might have put into creating the sketch and causing the generative AI service to give more deference to the sketch when the user has put significant effort into the sketch, and to accept the sketch as merely a source of general guidance with the sketch was provided with less effort. Additionally, the present technology takes steps to acknowledge that sketches might be an outline of any object without much fill coloring but that the outline might not reflect the intention of the user that a sketched object is to be created with or without fill and texture.

Another challenge for generative AI service is handling inputs in different styles and quality and converting such inputs into a consistent output style. It can be difficult for generative AI service to receive inputs in different styles and even more challenging to receive multiple different graphical inputs where the inputs are in different styles. This is made even more challenging when the user requests a particular output style.

The present technology addresses this shortcoming by preprocessing some graphical inputs into a more consistent style and by using adapters to adjust the generative AI service to be more adept at producing outputs in specific styles. Additionally, the present technology can take steps to harmonize multiple graphical inputs to give the generative AI service better guidance regarding how to combine the different graphical inputs into the desired output.

Another challenge in using generative AI service is that users often provide prompts that are somewhat general and do not adequately convey sufficient detail, and this can result in outputs from the generative AI service that do not meet the user's objective.

The present technology addresses this challenge by providing multiple applications that are configured to interface with the generative AI service. Within a specific application, particular use cases can be expected, and this permits application developers to design interfaces that are more effective at extracting inputs from users that can be used as prompts for the generative AI service.

For example, in the case of a drawing interface (whether in a drawing application, a note application, a presentation application, etc.) the drawing interface can extract a lot of user intent from various drawing inputs and textual prompts. The drawing interface can infer different intents from sketches as compared to input images or graphics, handwriting or typing as compared to signatures, etc. By providing a simple and intuitive interface, such generative AI service empowers users to bring their imagination to life with unprecedented case and flexibility. The sketch-based input serves as a direct channel for users to convey their creative vision, with the generative AI service working as an extension of their abilities, enriching and elevating the user's original concepts with high fidelity and creativity.

In another example, in the case of a photo application, a user interface can be provided which suggestions for prompts to encourage users to provide more descriptive prompts.

Applications can also be configured to provide system prompts that can enhance user-provided prompts.

One aspect of the present technology is the use of data available from various sources to improve the generation of images. The present disclosure contemplates that, in some instances, this gathered data may include photographs or other images that might include images or a user or other person, and such images might include metadata, such as location information. The present disclosure recognizes that the use of such personal information data, in the present technology, can be used to the benefit of users. For example, the personal information data can be used to allow users to make modifications to images or photos using generative AI service tools.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed and keeping data on personal devices. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

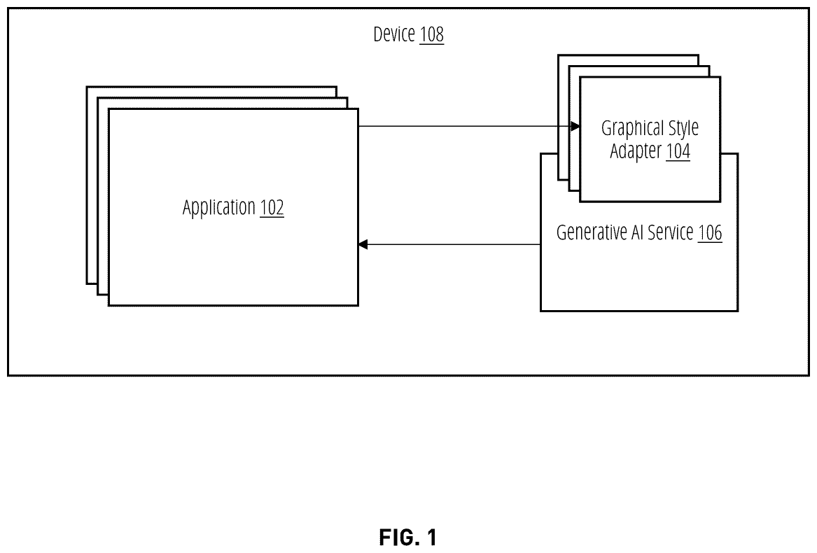

FIG. 1 illustrates an example system in accordance with some embodiments of the present technology. Although the example system depicts particular system components and an arrangement of such components, this depiction is to facilitate a discussion of the present technology and should not be considered limiting unless specified in the appended claims. For example, some components that are illustrated as separate can be combined with other components, some components can be divided into separate components, some components might not be present or needed, and additional components may be present.

As introduced above, the present technology attempts to provide a generative AI service to run locally on a computing device. The present technology utilizes a common generative AI service for a variety of use cases and supplements the common generative AI service with a variety of graphical style adapters. As illustrated in FIG. 1, the present technology includes one or more applications 102 interacting with a common generative AI service 106 through one or more graphical style adapters 104.

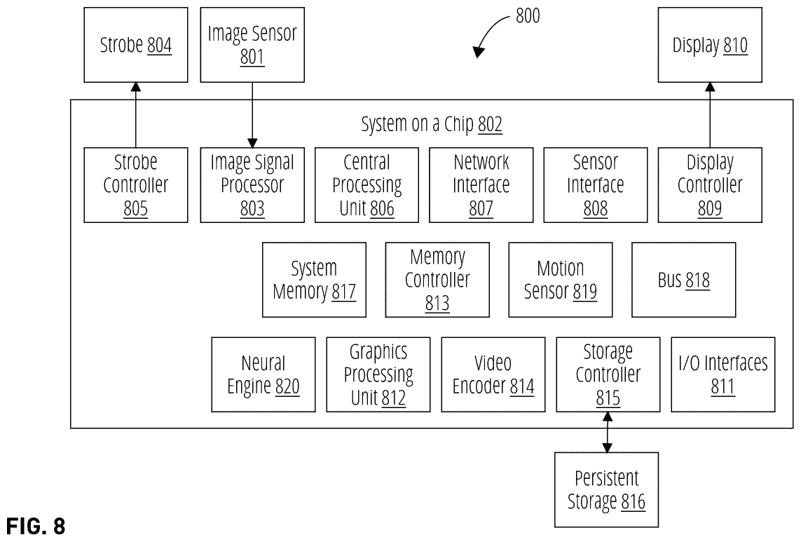

It is preferred that most functions of applications 102 are performed on a local computing device, or at a minimum, functions of applications 102 that occur over a networked connection are functions that are limited in scope and are configured to occur in a privacy-preserving manner. For example, some embodiments of the present technology utilizes networked resources, but photos from a user's photo library are not transmitted over a network and are maintained on device 108. The graphical style adapter 104 and generative AI service 106 can be executed by one or more processing components of system on a chip 802 illustrated in FIG. 8. In particular, neural engine 820 can be optimized for executing machine learning and artificial intelligence algorithms such as graphical style adapter 104 and generative AI service 106. Graphics processing unit 812, illustrated in FIG. 8, is also well suited for executing generative AI service 106 and graphical style adapter 104.

To enable the generative AI service 106 to provide the required quality while allowing the size of the common generative AI service to be small enough to run locally on device 108-even when a mobile computing device-the present technology utilizes graphical style adapters 104. Graphical style adapters 104 are configured to perform one or more functions to adapt generative AI service 106 to be more versatile while permitting the generative AI service 106 to be small enough to run on device 108. In some embodiments, graphical style adapters 104 are configured to enable generative AI service 106 to output different styles of images. In some embodiments, graphical style adapters 104 are configured to preprocess data into suitable inputs to generative AI service 106 to result in high-quality output.

Generative AI service 106 refers to artificial intelligence algorithms and models capable of creating or generating new content, data, or solutions based on learned patterns and data structures. Generative AI service 106 is used in various applications ranging from natural language processing to image and video generation. The present technology generally utilizes generative AI service 106 for use in creating images. Some types of generative AI service models that can be suitable for image generation include:
Generative Adversarial Networks (GANs) which are a class of AI algorithms where two neural networks, the generator and the discriminator, are trained simultaneously. The generator learns to produce content (such as images) that is increasingly indistinguishable from real data, while the discriminator learns to differentiate between real and generated content. GANs are particularly effective in generating realistic images, enhancing image quality, or converting one image type into another (e.g., sketches to photographs).
Variational Autoencoders (VAEs) which are generative models that use the principles of Bayesian inference to generate new data points. VAEs are effective in generating images, performing image enhancement, and more, by learning to encode data into a lower-dimensional space and then decoding it back, potentially with modifications.
Diffusion Models which are generative models that work by gradually adding and then reversing noise to/from data or images to create new instances or transform existing ones. This model simulates a diffusion process, which is mathematically akin to the physical process of particles moving from areas of higher concentration to lower concentration, but applies it in the data or image space. In its application, especially in fields such as artificial intelligence, computer vision, and machine learning, a diffusion model iteratively refines data or images by initially introducing randomness and then stepwise removing it across a series of stages to either create new data instances or to enhance existing ones. This process allows for the generation of highly realistic images, the enhancement of signal quality in noisy data, or even the creation of complex data structures. These models have shown remarkable results in generating high-quality, detailed images and in tasks such as image-to-image translation, super-resolution, and content creation with nuanced control over the generation process.
Transformers for Image Generation. Transformers are designed for natural language processing and have been adapted for generative tasks in the image domain through models like Vision Transformers (ViTs). These models can generate images by learning spatial hierarchies and relationships between different parts of an image, making them useful for generating complex scenes or detailed images from textual descriptions.

The present technology can utilize one or more of the generative AI service models referred to above. In some embodiments, the generative AI service models referred to above may be part of generative AI service 106 or part of graphical style adapters 104.

Adapters refer to specialized layers inserted into pre-trained generative AI service models to fine-tune them for specific tasks without the need to comprehensively retrain the entire network. These adapters allow for the efficient adaptation of a model to new domains or tasks by only training the parameters of the adapter layers, rather than the entire model, thereby saving significant computational resources and time. Adapters are particularly useful in scenarios where a generative AI model, initially trained on a broad dataset, needs to be customized for generating content in a specialized field or style. The architecture of an adapter typically involves a small neural network inserted between the layers of the original model. During the adaptation process, the weights of the original model are frozen, and only the weights of the adapter layers are updated based on the new target data or task. This method maintains the general knowledge the model has learned during its initial training while empowering it with the ability to generate or process data in ways tailored to specific requirements. Adapters offer a powerful method for leveraging the capabilities of large, general-purpose generative AI models across a wide range of applications, enabling customization and flexibility while minimizing the need for extensive retraining or the development of entirely new models from scratch.

The graphical style adapters 104 illustrated in FIG. 1 adapt the generative AI service 106 to generate content, particularly images, in a particular style. The graphical style adapters 104 can also be used to transform diverse inputs to be better suited for use with the generative AI service 106.

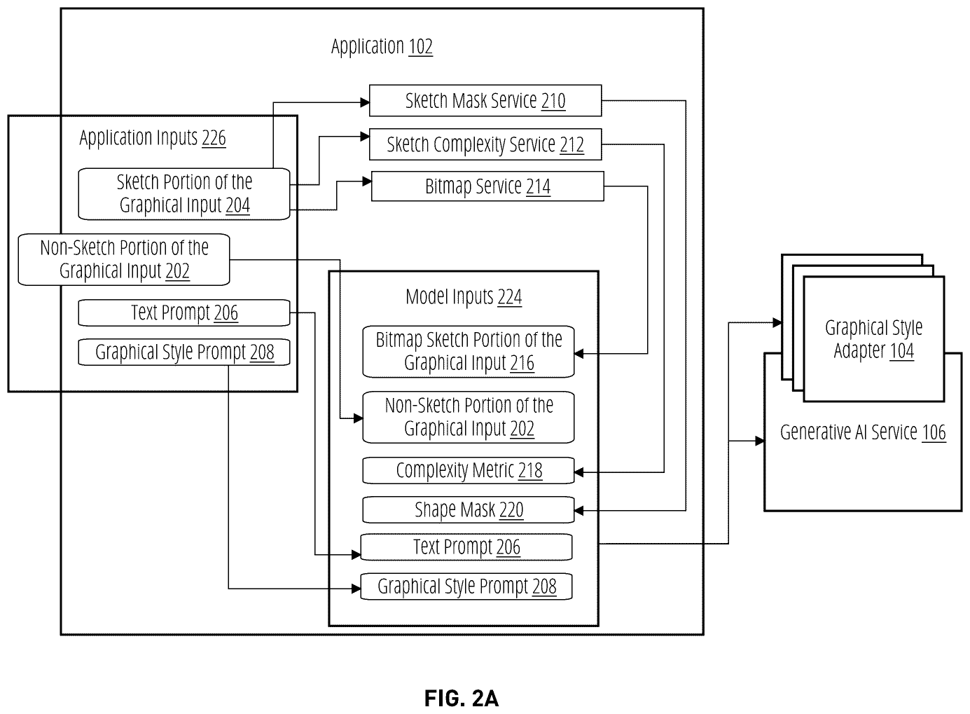

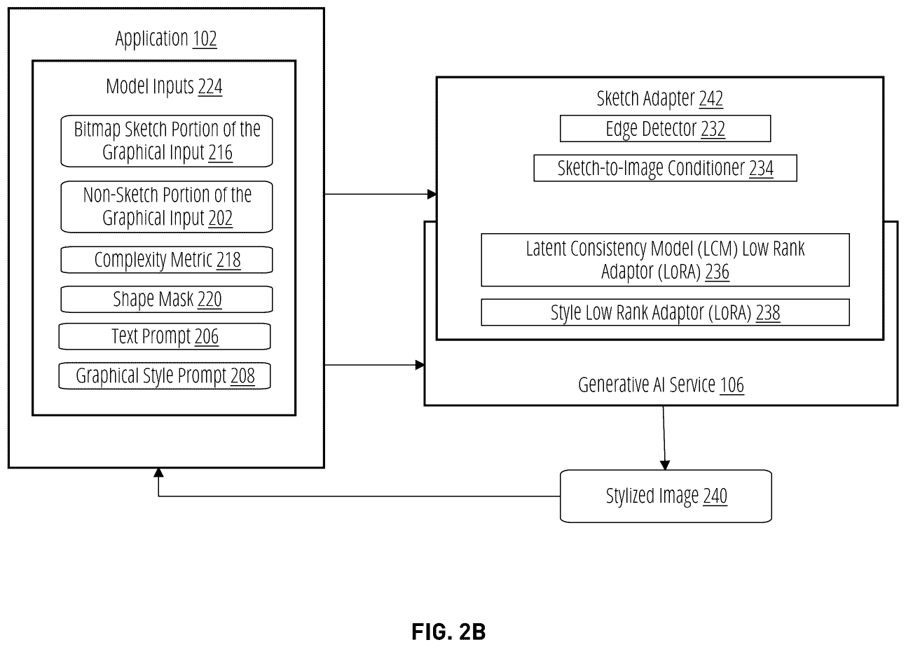

FIG. 2A and FIG. 2B illustrates a more detailed example of an application, graphical style adapter, and generative AI in accordance with some embodiments of the present technology. FIG. 2A provides additional detail with respect to application, while FIG. 2B provides additional detail with respect to a particular adapter and generative AI service. Although the example system depicts particular system components and an arrangement of such components, this depiction is to facilitate a discussion of the present technology and should not be considered limiting unless specified in the appended claims. For example, some components that are illustrated as separate can be combined with other components, some components can be divided into separate components, some components might not be present or needed, and additional components may be present.

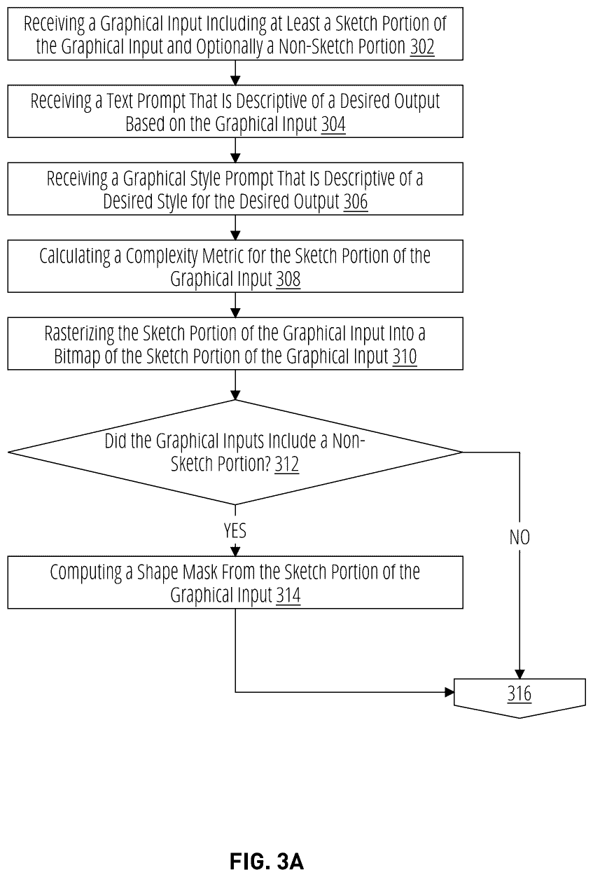

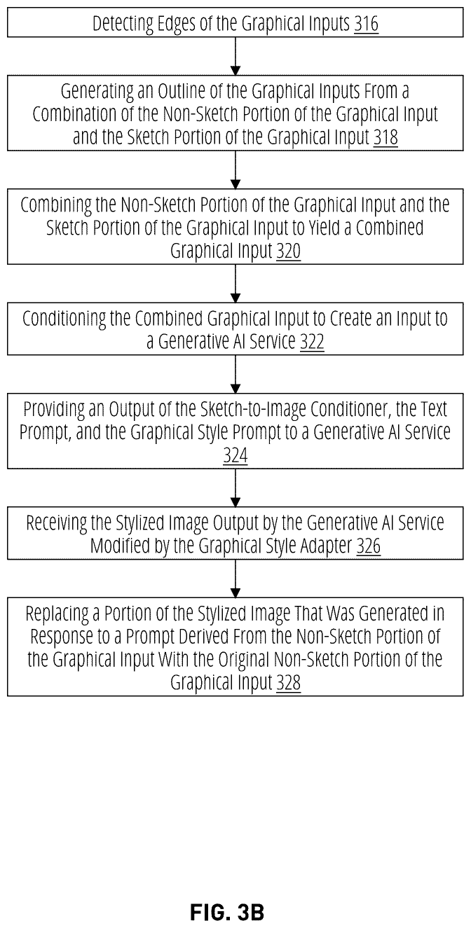

FIG. 2A and FIG. 2B will be explained in the context of FIG. 3A and FIG. 3B.

FIG. 3A and FIG. 3B illustrates an example routine for generating a stylized image from a graphical input in accordance with some embodiments of the present technology. In some embodiments, the graphical input includes a non-sketch portion of the graphical input and a sketch portion of the graphical input, but both are not required for the functioning of the present technology. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

While some operations are addressed as being performed by a particular component or service, this is for explanation purposes only, and it should be appreciated that reference to a specific component or service does not prevent the possibility that a higher-level device or service or a different device or service can perform the same function. It is explicitly intended that if a function is performed by a service on a system, device, container, or virtual machine, it should be appreciated that the system, device, container, or virtual machine is performing that function as part of executing the service.

According to some examples, the method includes receiving a graphical input including at least a sketch portion of the graphical input and optionally a non-sketch portion at block 302. A non-sketch portion of the graphical input can be a video, drawing, photo, a signature, etc. that can be pasted or uploaded into application 102. A sketch portion of the graphical input can be a drawing created within application 102. Often the sketch portion of the graphical input is created by a user operating an input device such as a touch pad, mouse, pencil, stylus, etc. to control a cursor.

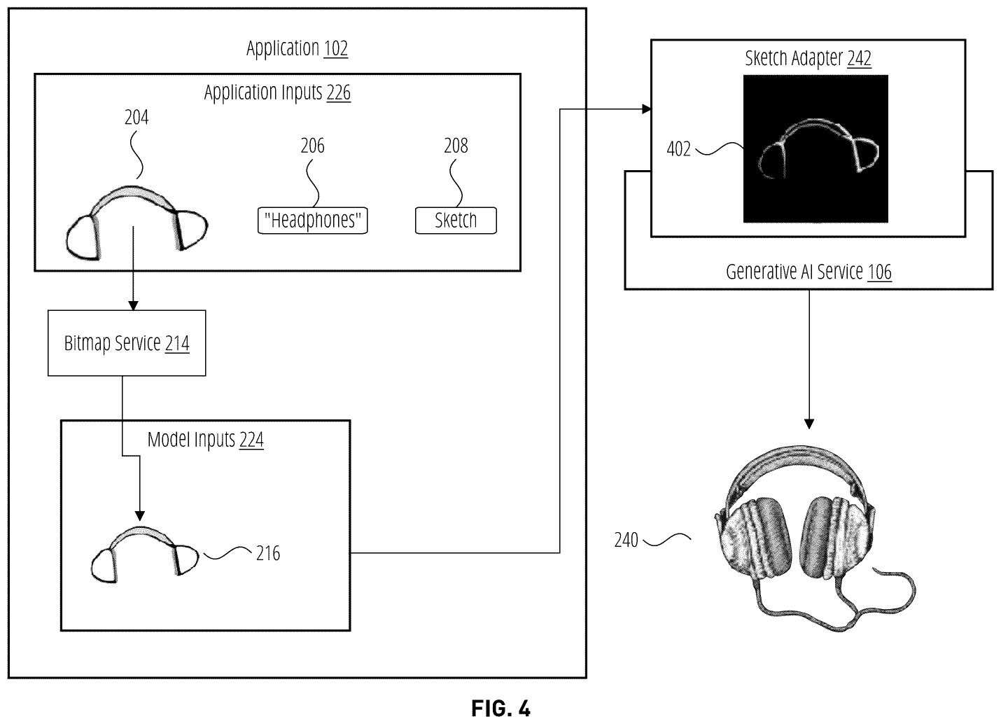

The sketch portion of the graphical input can be generally considered as a means for the user to graphically convey a direction to generative AI service 106. The sketch portion of the graphical input can be the only portion of the graphical input when the user intends to ask the generative AI service to generate an image based on the sketch portion of the graphical input. Or the sketch portion of the graphical input can be combined with one or more non-sketch portions of the graphical input when the user desires to instruct the generative AI service 106 to modify the non-sketch portions of the graphical input as indicated, in part, by the sketch portion of the graphical input. An example of a sketch portion of the graphical input is illustrated as sketch portion of the graphical input 204 in FIG. 4 and the headphones drawn on top of the chimpanzee in graphical inputs 502 in FIG. 4.

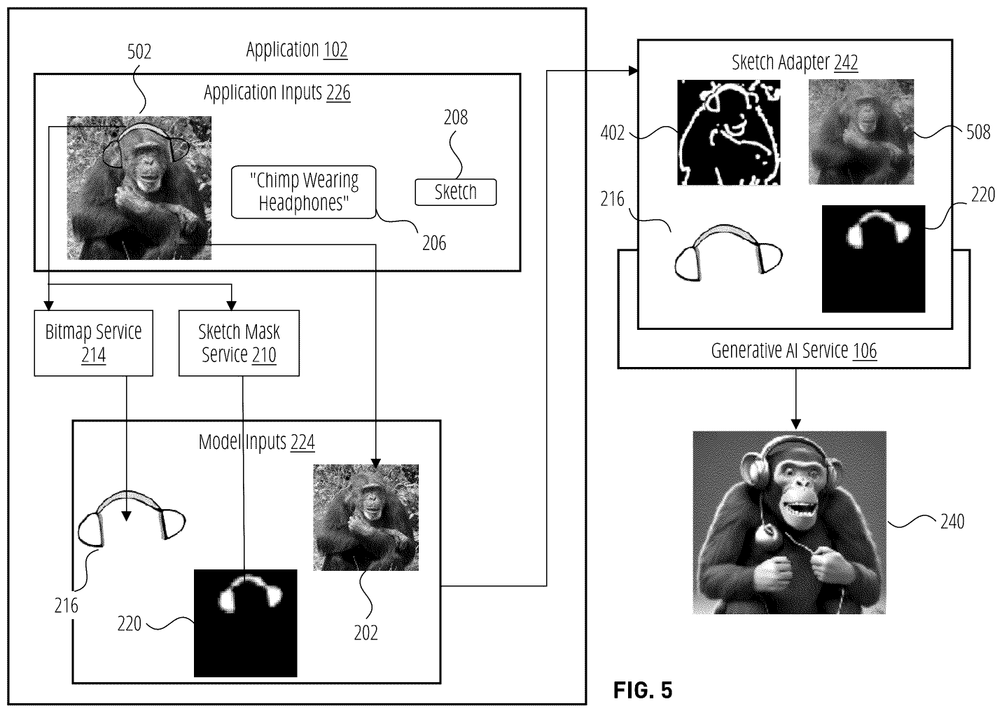

According to some examples, the method includes receiving a text prompt that is descriptive of a desired output based on the graphical input at block 304. For example, the application 102 illustrated in FIG. 1 may receive a text prompt that is descriptive of a desired output based on the graphical input. The text prompt can be another input whereby the user conveys a direction to generative AI service 106. In some embodiments, the text prompt can describe what what is shown in the sketch as shown in FIG. 4 where the text prompt 206 is ‘headphones.’ In some embodiments, the text prompt can describe the intended output, such in FIG. 5 where text prompt 206 is “chimp wearing headphones” or can describe the modifications that are desired, such as “draw this gorilla wearing headphones like these.”

In some embodiments, the user does not need to provide a text prompt. The application 102 can include a prompt generation service, which may be a generative AI service itself, to analyze the graphical inputs and generate a text prompt for review by the user. This variation of the present technology might have some advantages if the prompt generation service provides more descriptive prompts than a user might provide. Even if the prompt does not properly characterize the user's intent, the proposal of a detailed prompt would cause the user to revise the prompt in more detail than the user might have otherwise provided.

The application depicted in FIG. 2A and FIG. 2B can be configured to output drawings in a variety of possible graphical styles. For example, an output style might be a sketch output style, an animation output style, a realistic output style, etc. Therefore, according to some examples, the method includes receiving a graphical style prompt that is descriptive of a desired style for the desired output at block 306. For example, the application 102 illustrated in FIG. 1 may receive a graphical style prompt that is descriptive of a desired style for the desired output.

In block 302, block 304, and block 306, application 102 is depicted as receiving application inputs 226 including optionally a non-sketch portion of the graphical input 202, sketch portion of the graphical input 204, text prompt 206, and graphical style prompt 208. Application inputs 226 including the sketch portion of the graphical input 204, text prompt 206, and graphical style prompt 208 are shown within application 102 because they are created within application 102, whereas the optional non-sketch portion of the graphical input 202 is brought into application 102.

As introduced above, one type of visual input that can be difficult for generative AI service 106 to interpret well enough to generate a satisfactory output is sketch portion of the graphical input 204. Sketch portions of the graphical input 204 can be difficult to input because different users have different abilities, and even a skilled user might make a quick sketch in one instance and a detailed sketch in another instance. Thus, properly interpreting an input sketch so that a generative AI service 106 can provide proper attention to attributes of a sketch in some instances while understanding the sketch as higher-level guidance to convey a concept in other instances is important to generating a satisfactory output.

One mechanism employed by the present technology to address this shortcoming of generative AI service 106 is by using a sketch complexity metric as a proxy to convey how much effort a user might have put into creating the sketch and causing the generative AI service to give more deference to the sketch when the user has put significant effort into the sketch, and to accept the sketch as merely a source of general guidance with the sketch was provided with less effort.

According to some examples, the method includes calculating a complexity metric for the sketch portion of the graphical input at block 308. For example, the sketch complexity service 212 illustrated in FIG. 2A may calculate a complexity metric for the sketch portion of the graphical input. The complexity metric can be based on factors such as a number of strokes within the sketch, a number of shapes within the sketch, curvature of one or more strokes, etc. In some embodiments, the complexity metric can also take into account the amount of time used to draw the sketch. The complexity metric can be a heuristic designed to convey to the generative AI service 106 whether sketch details should be preserved in the output or whether the sketch is just general guidance of a region or aspect of the graphical inputs to be adjusted. In some embodiments, the complexity metric can be determined by a machine learning algorithm and/or a heuristic.

According to some examples, the method includes rasterizing the sketch portion of the graphical input into a bitmap of the sketch portion of the graphical input at block 310. For example, the bitmap service 214 illustrated in FIG. 2A may rasterize the sketch portion of the graphical input into a bitmap of the sketch portion of the graphical input. If the sketch portion of the graphical input is already in a pixel format, this step can be obviated. As will be addressed later, the bitmap of the sketch portion of the graphical input is an input into one of the graphical style adapters 104.

When a non-sketch portion is included as part of the graphical inputs some additional steps can be taken. Accordingly, the method includes determining whether the graphical inputs include a non-sketch portion at decision block 312. For example, application 102 can determine whether the graphical inputs include a non-sketch portion. When a non-sketch portion is part of the graphical inputs, the method proceeds to block 314, but when the graphical input is made up of only the sketch, the method proceeds to block 316 in FIG. 3B.

When the graphical inputs includes a non-sketch portion, the method includes computing a shape mask from the sketch portion of the graphical input at block 314. For example, the sketch mask service 210 illustrated in FIG. 2A may compute a shape mask from the sketch portion of the graphical input. The present technology takes steps to acknowledge that sketches might be an outline of any object without much fill coloring but that the outline might not reflect the intention of the user that a sketched object is to be created with or without fill and texture. Accordingly, even if the sketch is an outline or a line drawing, the shape mask might be filled in to account for the fact that sketches might be drawn quickly and lack detail.

The sketch mask service 210 can be a heuristic, algorithm, or machine learning algorithm that intelligently determines whether the sketch portions of the graphical input should include fill or not and whether portions of the sketch portion of the graphical input should obscure portions of the non-sketch portion of the graphical input. This can be based on information implied from what the sketch is supposed to represent and from how the user combined the sketch portions of the graphical input with the non-sketch portions of the graphical input. An example of a shape mask is shown as shape mask 220 in FIG. 5, where the sketch mask is created from a sketch of headphones.

A shape mask is a computational technique used to define a region of interest within an image. This technique involves the use of shapes to create a mask that outlines or covers a specific area of an image. A shape mask is typically utilized to isolate specific parts of an image for further processing or analysis.

Collectively, the bitmap sketch portion of the graphical input 216, non-sketch portion of the graphical input 202, complexity metric 218, shape mask 220, text prompt 206, and graphical style prompt 208 are model inputs 224 that are fed into an appropriate graphical style adapter 104 and/or generative AI service 106. For example, model inputs 224, such as text prompt 206 and graphical style prompt 208, can be provided to the generative AI service 106 and can be used, among other users, to select the appropriate graphical style adapter 104. The other model inputs 224 can be fed into the selected graphical style adapter 104 and thereby fed into the generative AI service 106.

In the example illustrated in FIG. 2A and FIG. 2B, the graphical style prompt 208 is for a sketch output style and accordingly, as illustrated in FIG. 2B, the sketch adapter 242 was chosen from the graphical style adapters 104. While sketch adapter 242 is shown with specific subcomponents, it should be appreciated that sketch adapter 242 can have more, less, or different components. And components of the sketch adapter 242 can also be part of other adaptors. For example, the edge detector 232, addressed below, will likely be a part of any adapter that is receiving sketches as part of the input, regardless of the selected output style. Furthermore, individual components of sketch adapter 242 (and of application 102, too) may be executed independently of the other components of sketch adapter 242 (and application 102). In some embodiments, the sketch adapter 242 is configured to cause generative AI service 106 to output generated images that generally look like they are a hand-drawn sketch. While, admittedly, there can be a lot of variation styles even within the genre of hand-drawn sketches, the sketch adapter 242 will output images in a style of sketch that correspond to the training set of sketch images on which sketch adapter 242 was trained.

According to some examples, the method includes detecting edges of the non-sketch portion of the graphical input and the bitmap sketch portion of the graphical input 216 at block 316. For example, edge detector 232 illustrated in FIG. 2B detects edges of the non-sketch portion of the graphical input (when present) and the sketch portion of the graphical input. This step may be important when sketches are part of the input. As addressed herein, sketches can have some ambiguity as an input source. It can be hard to tell what parts of the sketch are meaningful, and because some sketches might be provided by less skilled users, the importance of some lines may be ambiguous. Accordingly, edge detector 232 is used to identify major lines and edges of the object to generate an outline shape sketch portion of the graphical input 204. An example of an output of the edge detector 232 is an outline of the graphical inputs 402 in FIG. 4.

When a non-sketch portion of the graphical input 202 is also present, the graphical input (sketch portion of the graphical input and non-sketch portion of the graphical input) can be processed separately by edge detector 232 to generate an outline. An example of an output of the edge detector 232 is an outline of the graphical inputs 402 in FIG. 5.

According to some examples, the method includes generating an outline of the graphical inputs from a combination of the output of the edge detector after processing the non-sketch portion of the graphical input and the bitmap sketch portion of the graphical input 216 at block 318. For example, the sketch adapter 242 illustrated in FIG. 2B may generate an outline of the graphical inputs from a combination of the non-sketch portion of the graphical input and the bitmap sketch portion of the graphical input 216.

In some embodiments, the outline of the graphical inputs can be created by sending the sketch and the non-sketch portion of the graphical input into the edge detector 232 together and receiving the combined output in a single operation.

In some embodiments, one or more heuristics, algorithms, or machine learning algorithms are employed to create the outline of the graphical inputs. For example, it can be challenging to determine when portions of the sketch should obscure portions of the non-sketch portion of the graphical input and vice-versa. Some techniques that are useful in creating the outline of the graphical inputs include generating an alpha shape from the sketch and creating an outline from the alpha shape. Further, heuristics can determine if the outline should include filled-in portions. One such heuristic might fill in portions of a sketch when the user only draws an outline, but if the user sketches with more detail such that some portions of fill are included in the sketch (e.g., a solid colored donut) the outline should not receive additional fill as it can be assumed that the user has sketched the fill that should be present.

The processing of the graphical inputs in this way can be important because the outline of the graphical inputs harmonizes the styles of the graphical inputs. Even if a rough sketch were combined with a photo-realistic image, the outline of the graphical inputs does not discriminate based on style.

According to some examples, the method includes combining the non-sketch portion of the graphical input and the sketch portion of the graphical input to yield a combined graphical input at block 320. For example, the sketch adapter 242 illustrated in FIG. 2B may combine the non-sketch portion of the graphical input and the sketch portion of the graphical input to yield a combined graphical input.

The combining the portions of the graphical input can include several steps. First, any non-sketch portion of the graphical inputs should be processed to have attributes more similar to a sketch. In this instance, the adapter includes a sketch-to-image conditioner (address in subsequent steps) which is trained to accept sketches as inputs, so it is helpful to adjust non-sketch portions of the graphical input to be more in a sketch style. For example, if the non-sketch portion of the graphical input is a photo-realistic image, it may have too much detail for a sketch, and the colors might be too sharp. Thus sketch adapter 242 can process the non-sketch portions of the graphical input into a low-resolution version of the non-sketch portion of the graphical input. An example of a low-resolution version of the non-sketch portion of the graphical input is shown as low-resolution version of the non-sketch portion of the graphical input 508 in FIG. 5. Low-resolution version of the non-sketch portion of the graphical input 508 appears similar to the non-sketch portion 202 of graphical inputs 502 as shown in FIG. 5, but the image is in a lower resolution and includes less color detail, amongst other potential differences.

An additional step can include merging the low-resolution version of the non-sketch portion of the graphical input with the bitmap of the sketch portion of the graphical input and the shape mask of the sketch portion of the graphical input. The combination of these sources helps blend together the attributes of the sources. In particular, the combined graphical input will include color and texture information from the graphical inputs, though some of the detail will have been lost from the non-sketch portion of the graphical input. Additionally, the shape mask conveys information about regions of an outlined shape in a sketch that should be filled and thus also guides how the non-sketch portions of the graphical input should be combined with the sketch portions of the graphical input.

According to some examples, the method includes conditioning the combined graphical input to create an input to a generative AI service at block 322. For example, the sketch-to-image conditioner 234 illustrated in FIG. 2B may condition the combined graphical input to create an input to a generative AI service. The sketch-to-image conditioner 234 can receive inputs including the outline of the graphical inputs, the combined graphical input, and the complexity metric.

The sketch-to-image conditioner 234 can be a neural network trained to provide inputs into generative AI service 106. In particular, the sketch-to-image conditioner 234 is trained to use its inputs to adjust the amount of focus that should be placed on the attributes sketch portion of the graphical input, and to provide good outputs into the diffusion model that are useful for creating an output in the particular graphical style (e.g. in FIG. 2B, a sketch graphical style).

Although some of the inputs into the sketch-to-image conditioner 234 are redundant, both the bitmap sketch portion of the graphical input 216 and the outline of the graphical inputs are important so that the generative AI service 106 receives inputs about the overall shape to be drawn and information about colors and style that is implied by the combined graphical inputs.

The sketch-to-image conditioner 234 is trained to adjust parameters in the sketch-to-image conditioner to control how the diffusion model behaves given a specific conditioning input. This allows for training the sketch-to-image conditioner 234 on a fixed, pre-trained generative AI service 106 such that the generative AI service produces desired outputs based on the provided conditioning. Feedback is provided to sketch-to-image conditioner 234 based on the outputs of the generative AI service 106. When generative AI service 106 produces good output, the sketch-to-image conditioner 234 can be reinforced, and when the output is less desirable, feedback encourages learning by the sketch-to-image conditioner 234 to seek better parameters to input into the generative AI service 106.

To effectively train the sketch-to-image conditioner 234, an extensive dataset consisting of sketches and corresponding images is required as inputs to the conditioner. The collected data includes triplets comprising a desired output image, its representative sketch, and a textual description of the image. By utilizing this data, image synthesis can be performed using the generative AI service 106 while training the sketch-to-image conditioner 234.

Collecting a large dataset of triplets of image, sketch, and text data can be a challenge. To overcome this challenge, augmentation techniques have been developed to generate sketches from normal photographs. These techniques include edge detection, color quantization, and masking individual parts of the image. For example, a photograph or other realistic image is processed into an image that has a lot of the properties of a sketch-similar to the processing at block 320. In some embodiments, an edge detector (the same or similar to the edge detector 232) is used to get the edge output from the image. The colors of the image are quantized in order to be more aligned with the default colors that users are likely going to use to create sketches. Parts of the image are also masked to be removed from the image to account for the fact that when users draw sketches, they often will not draw every aspect of an image. Users often draw some parts, and the other parts are described texturally. In particular, users will not properly color in textures. Masking to remove portions of detail from a realistic image can account for this difference. These techniques can be used to collect a sufficient data sample to train the sketch-to-image conditioner 234.

To train the sketch-to-image conditioner using these augmented images, normal training images from the diffusion model are processed to resemble sketches, and then the conditioning layer is trained such that it influences the diffusion model to output desired results based on the provided conditioning input.

According to some examples, the method includes providing an output of the sketch-to-image conditioner, the text prompt, and the graphical style prompt to a generative AI service at block 324. For example, the sketch adapter 242 illustrated in FIG. 2B may provide an output of the sketch-to-image conditioner to the generative AI service 106 while the text prompt, and the graphical style prompt are provided by the application 102. The graphical style prompt invokes a graphical style adapter of the generative AI service.

As depicted in FIG. 2B the generative AI service 106 is further modified by portions of the sketch adapter 242. In particular, the Latent Consistency Model (LCM) Low Rank Adaptor (LoRA) 236 and style Low Rank Adaptor (LoRA) 238. LoRA stands (Low-Rank Adaptation) is a technique used to adapt pre-trained models with minimal additional parameters. LoRA is particularly useful in the field of natural language processing (NLP) and computer vision, where it allows for efficient fine-tuning of large-scale pre-trained models. The core idea behind LoRA is to introduce trainable low-rank matrices that adapt the weights of the pre-existing layers in the model, enabling the model to learn task-specific features without requiring the training of the entire network again. This method helps in reducing the computational cost and memory usage during the fine-tuning phase, making it easier to deploy models in resource-constrained environments or applications that demand fast adaptation to new tasks or data.

The Latent Consistency Model (LCM) Low Rank Adaptor (LoRA) 236 is configured to make the generative AI service 106 more efficient by causing the generative AI service 106 to output a latent consistent representation of the image.

The style Low Rank Adaptor (LoRA) 238 is configured to adjust the output of the generative AI service 106 to output images in the desired style.

According to some examples, the method includes receiving the stylized image output by the generative AI service modified by the graphical style adapter at block 326. For example, the generative AI service 106 illustrated in FIG. 1 may receive the stylized image 240 output by the generative AI service modified by the graphical style adapter.

In addition to the embodiments addressed above that help to make the generative AI service 106 efficient enough to run on a personal computing device, such as a smartphone or laptop, further efficiency can be achieved by bringing components of the system depicted in FIG. 2A and FIG. 2B into and out of memory as needed. For example, sketch mask service 210, sketch complexity service 212, bitmap service 214, edge detector 232, sketch-to-image conditioner 234, etc. into and out of memory to conserve memory. These services can be brought into memory to perform their specific task and then removed from memory as data is passed down the pipeline.

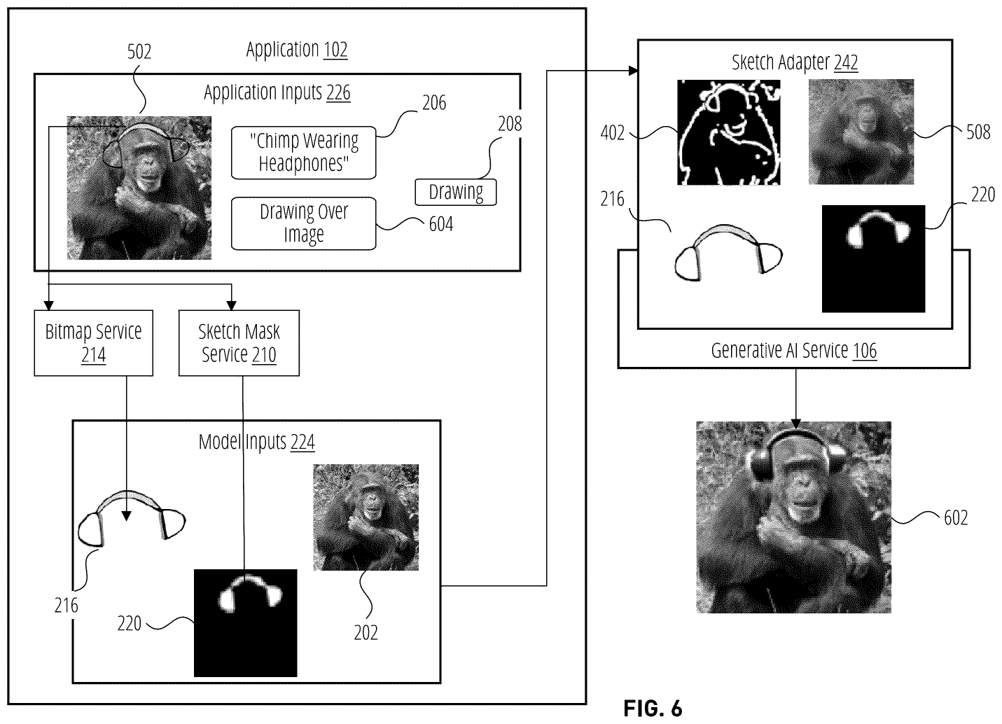

In some embodiments, application 102 can offer different modes of operation. Thus far, the present description has addressed a mode where inputs, including at least one sketch input, are used to create a stylized image that corresponds to a desired style. Another mode of operation might be to add a drawing over an input image, such as the non-sketch portion of the graphical input. An example output of this mode is stylized drawing over non-sketch portion 602 illustrated in FIG. 6. When this mode is selected additional processing can occur on the stylized image 240 provided by the generative AI service 106. According to some examples, the method includes replacing a portion of the stylized image that was generated in response to a prompt derived from the non-sketch portion of the graphical input with the original non-sketch portion of the graphical input at block 328. For example, the application 102 illustrated in FIG. 1 may replace a portion of the stylized image that was generated in response to a prompt derived from the non-sketch portion of the graphical input with the original non-sketch portion of the graphical input. More particularly, the shape mask 220 can be used to extract a second portion of the stylized image that was generated in response to a prompt derived from the sketch portion of the graphical input. The unmasked portions (i.e., the rest of the image) can be restored from the original non-sketch sketch portion of the graphical input 204 to result in an image that includes the second portion of the stylized image blended with the non-sketch portion of the graphical input.

As described herein, the present technology is useful for receiving sketches as input prompts and conditioning sketches to be acceptable input for a generative AI service. The present technology is also useful for receiving inputs that are in a variety of different styles that when used as a prompt for a generative AI service can result in a stylized image with a single, consistent style. The present technology is particularly adept at when on of the input styles is a sketch. The present technology is also useful for receiving a graphical prompt in a first input style and outputting a different graphical style. The present technology is useful for adding or modifying an input non-sketch portion of the graphical input based on sketch portions of the graphical input. Each of these uses is made possible through the descriptions provided above by using selected steps or all of the steps addressed herein.

FIG. 4 illustrates a high-level system diagram providing an example of a sketch graphical input and transformations of the sketch graphical input to result in the output stylized image in accordance with some embodiments of the present technology. Although the example system depicts particular system components and an arrangement of such components, this depiction is to facilitate a discussion of the present technology and should not be considered limiting unless specified in the appended claims. For example, some components that are illustrated as separate can be combined with other components, some components can be divided into separate components, some components might not be present or needed, and additional components may be present.

For example, FIG. 4 illustrates application 102 receiving a sketch portion of the graphical input 204, which are headphones, as indicated by text prompt 206. The user has provided a graphical style prompt 208 indicating a sketch output style.

The bitmap service 214 can process the sketch portion of the graphical input 204 into the bitmap sketch portion of the graphical input 216. As indicated in the description above, additional processing is also performed to create a sketch complexity metric to generate model inputs 224. Once again, as described herein, there are more model inputs 224 than are illustrated in FIG. 4.

The model inputs 224 are used as inputs into the sketch adapter 242 and the generative AI service 106 to generate the output stylized image 240. FIG. 4 illustrates one processing step of sketch adapter 242-the creation of the outline of the graphical inputs 402 from the sketch portion of the graphical input 204.

FIG. 5 illustrates a high-level system diagram providing an example of a sketch graphical input and a non-sketch portion of the graphical input and transformations of the graphical inputs to result in the output stylized image in accordance with some embodiments of the present technology. Although the example system depicts particular system components and an arrangement of such components, this depiction is to facilitate a discussion of the present technology and should not be considered limiting unless specified in the appended claims. For example, some components that are illustrated as separate can be combined with other components, some components can be divided into separate components, some components might not be present or needed, and additional components may be present.

For example, FIG. 5 illustrates application 102 receiving a sketch portion of the graphical input 204 and non-sketch portion of the graphical input 202 as the graphical inputs 502, which are a chimp wearing headphones, as indicated by text prompt 206. The user has provided a graphical style prompt 208 indicating a sketch output style.

The bitmap service 214 can process the sketch portion of the graphical input 204 into the bitmap sketch portion of the graphical input 216. As indicated in the description above, additional processing is also performed to create a sketch complexity metric to generate model inputs 224. FIG. 5 also illustrates the shape mask 220 generated by the sketch mask service 210. Once again, as described herein, there are more model inputs 224 than are illustrated in FIG. 5.

The model inputs 224 are used as inputs into the sketch adapter 242 and the generative AI service 106 to generate the output stylized image 240. FIG. 5 illustrates processing steps of the sketch adapter 242 such as the creation of the outline of the graphical inputs 402 from the graphical inputs 502 and the low-resolution version of the non-sketch portion of the graphical input 508.

FIG. 6 illustrates a high-level system diagram providing an example of a sketch graphical input and a non-sketch portion of the graphical input and transformations of the graphical inputs to result in a portion of the output stylized image overlaid the input non-sketch portion of the graphical input in accordance with some embodiments of the present technology. Although the example system depicts particular system components and an arrangement of such components, this depiction is to facilitate a discussion of the present technology and should not be considered limiting unless specified in the appended claims. For example, some components that are illustrated as separate can be combined with other components, some components can be divided into separate components, some components might not be present or needed, and additional components may be present.

For example, FIG. 6 illustrates application 102 receiving a sketch portion of the graphical input 204 and non-sketch portion of the graphical input 202 as the graphical inputs 502, which are a chimp wearing headphones, as indicated by text prompt 206. The user has provided a graphical style prompt 208 indicating a drawing output style and a mode 604 indicating a ‘drawing over image’ mode.

The bitmap service 214 can process the sketch portion of the graphical input 204 into the bitmap sketch portion of the graphical input 216. As indicated in the description above, additional processing is also performed to create a sketch complexity metric to generate model inputs 224. FIG. 5 also illustrates the shape mask 220 generated by the sketch mask service 210. Once again, as described herein, there are more model inputs 224 than are illustrated in FIG. 5.

The model inputs 224 are used as inputs into the sketch adapter 242 and the generative AI service 106 to generate the output stylized image. FIG. 6 illustrates processing steps of the sketch adapter 242 such as the creation of the outline of the graphical inputs 402 from the graphical inputs 502 and the low-resolution version of the non-sketch portion of the graphical input 508. The output stylized image is not shown here, but the output would be a more realistic style drawing of the chimp wearing headphones. The chimp would not be exactly the same chimp as it would have been rendered by generative AI service 106.

To get to the output desired by the user, which is the chimp provided as the non-sketch portion of the graphical input 202 wearing a drawing of headphones, processing is performed that can use the shape mask 220 to extract the headphones from the stylized image. The rest of the stylized image can be replaced with the non-sketch portion of the graphical input 202. In some embodiments, some additional image processing is needed to blend the masked image of the drawn headphones with the image of the chimp provided as the non-sketch portion of the graphical input 202 to result in the final output stylized drawing over non-sketch portion 602.

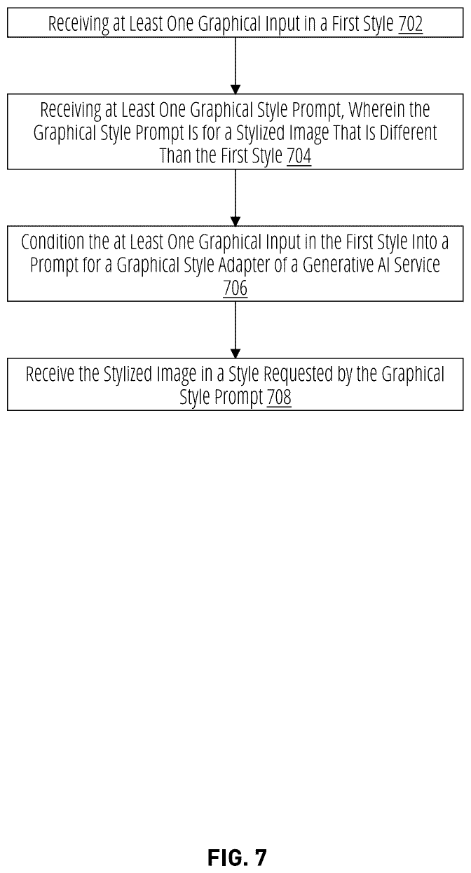

FIG. 7 illustrates an example routine for receiving an input in a first style and providing an output as a stylized image in a style that is different than the first style in accordance with some embodiments of the present technology. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

The method illustrated in FIG. 7 includes overlap with the method addressed in FIG. 3A and FIG. 3B, but FIG. 7 is provided to explicitly acknowledge that receiving any input in a first input style and outputting in a different style can be separately useful. While FIG. 7 illustrates key steps, it is explicitly contemplated that any steps addressed herein are contemplated.

According to some examples, the method includes receiving at least one graphical input in a first style at block 702. For example, the application 102 illustrated in FIG. 1 may receive at least one graphical input in a first style. For example, this could be the non-sketch portion of the graphical input.

According to some examples, the method includes receiving at least one graphical style prompt, wherein the graphical style prompt is for a stylized image that is different than the first style at block 704. For example, the application 102 illustrated in FIG. 1 may receive at least one graphical style prompt, wherein the graphical style prompt is for a stylized image that is different than the first style. For example, the graphical style prompt can be to output a sketch stylized image from the non-sketch portion of the graphical input.

According to some examples, the method includes conditioning the at least one graphical input in the first style into a prompt for a graphical style adapter of a generative AI service at block 706. For example, the sketch-to-image conditioner 234 illustrated in FIG. 2B may condition the at least one graphical input in the first style into a prompt for a graphical style adapter of a generative AI service. For example, this can be any or all of the processes associated with sketch adapter 242.

According to some examples, the method includes receiving the stylized image in a style requested by the graphical style prompt at block 708. For example, the application 102 illustrated in FIG. 1 may receive the stylized image 240 in a style requested by the graphical style prompt.

FIG. 8 is a system diagram illustrating device 800 in accordance with some embodiments of the present technology. Although the example system depicts particular system components and an arrangement of such components, this depiction is to facilitate a discussion of the present technology and should not be considered limiting unless specified in the appended claims. For example, some components that are illustrated as separate can be combined with other components, some components can be divided into separate components, some components might not be present or needed, and additional components may be present.

Device 800 may perform various operations including image processing. For this and other purposes, the device 800 may include, among other components, image sensor 801, system-on-a system on a chip 802, system memory 817, persistent storage 816, motion sensor 819, and display 810.

Image sensor 801 is a component for capturing image data and may be embodied, for example, as a complementary metal-oxide-semiconductor (CMOS) active-pixel sensor) a camera, video camera, or other devices. Image sensor 801 generates raw image data that is sent to system on a chip 802 for further processing. In some embodiments, the image data processed by system on a chip 802 is displayed on display 810, stored in system memory 817, persistent storage 816 or sent to a remote computing device via network connection. The raw image data generated by image sensor 801 may be in a Bayer color filter array (CFA) pattern (hereinafter also referred to as “Bayer pattern”).

Strobe controller 805 is a component for controlling variable features of strobe 804. Some attributes of the strobe 804 profile that can be adjusted include a strobe duration, a strobe strength, strobe spectrum, and an angular profile. For example, some strobe 804 devices can include strobes with adjustable intensities, and some strobe devices include multiple strobes, maybe with different emission spectra that can be activated independently to control an angular profile or spectrum of the light emitted from the strobe. An angular profile refers to the pattern and spread of light emitted from the strobe unit as it disperses over an area, as well as how this dispersion changes at different angles relative to the strobe. This can include how the intensity and distribution of light vary as one moves away from the central axis of the strobe, which is directly in front of it, towards the sides.

Motion sensor 819 is a component or a set of components for sensing motion of device 800. Motion sensor 819 may generate sensor signals indicative of orientation and/or acceleration of device 800. The sensor signals are sent to system on a chip 802 for various operations such rotating images displayed on display 810, and tracking motion of the image sensor 801 during image capture.

Display 810 is a component for displaying images as generated by system on a chip 802. Display 810 may include, for example, liquid crystal display (LCD) device or an organic light emitting diode (OLED) device. Based on data received from system on a chip 802, display 810 may display various images, such as menus, selected operating parameters, images captured by image sensor 801 and processed by system on a chip 802, and/or other information received from a user interface of device 800 (not shown).

System memory 817 is a component for storing instructions for execution by system on a chip 802 and for storing data processed by system on a chip 802. System memory 817 may be embodied as any type of memory including, for example, dynamic random access memory (DRAM), synchronous DRAM (SDRAM), double data rate (DDR, DDR2, DDR3, etc.) RAMBUS DRAM (RDRAM), static RAM (SRAM) or a combination thereof. In some embodiments, system memory 817 may store pixel data or other image data or statistics in various formats. System memory 817 can be accessible by many of the components of the system on a chip 802, including, but not limited to the central processing unit 806, graphics processing unit 812, and neural engine 820.

Persistent storage 816 is a component for storing data in a non-volatile manner. Persistent storage 816 retains data even when power is not available. Persistent storage 816 may be embodied as read-only memory (ROM), NAND or NOR strobe memory or other non-volatile random access memory devices.

System on a chip 802 is embodied as one or more integrated circuit (IC) chips and performs various data processing processes. System on a chip 802 may include, among other components, image signal processor 803, one or more central processing unit 806, network interface 807, sensor interface 808, display controller 809, one or more graphics processing unit 812, memory controller 813, video encoder 814, storage controller 815, one or more neural engine 820 and various other input/output (I/O) I/O interfaces 811, and bus 818. Some components of system on a chip 802 can be connected directly to system memory 817, while other components are connect to other components by bus 818. System on a chip 802 may include more or fewer components than those shown in FIG. 8.

Image signal processor 803 (ISP) is hardware that performs various stages of an image processing pipeline. In some embodiments, image signal processor 803 may receive raw image data from image sensor 801, and process the raw image data into a form that is usable by other subcomponents of system on a chip 802 or components of device 800. image signal processor 803 may perform various image-manipulation operations such as image translation operations, horizontal and vertical scaling, color space conversion and/or image stabilization transformations.

Central processing unit 806 (CPU) may be embodied using any suitable instruction set architecture, and may be configured to execute instructions defined in that instruction set architecture. Central processing unit 806 may be general-purpose or embedded processors using any of a variety of instruction set architectures (ISAs), such as the x86, PowerPC, SPARC, RISC, ARM or MIPS ISAs, or any other suitable ISA. Although a single CPU is illustrated in FIG. 8, system on a chip 802 may include multiple CPUs. In multiprocessor systems, each of the CPUs may commonly, but not necessarily, implement the same ISA.

Graphics processing unit 812 (GPU) is graphics processing circuitry for performing graphical data. For example, GPU may render objects to be displayed into a frame buffer (e.g., one that includes pixel data for an entire frame). Graphics processing unit 812 may include one or more graphics processors that may execute graphics software to perform a part or all of the graphics operation, or hardware acceleration of certain graphics operations.

Neural engine 820 includes one or more processing cores optimized for machine learning tasks including training and inference tasks. Neural engine 820 enables rapid processing of artificial intelligence (AI) and machine learning (ML) operations. Neural engine 820 is optimized for tasks such as advanced image processing, natural language processing, and pattern recognition, significantly improving the efficiency and speed of AI-related processes. Its architecture is designed to support a wide range of machine learning models while being highly energy-efficient, thereby enhancing the user experience through faster, more responsive applications and functionalities that rely on AI and ML technologies.

I/O interfaces 811 are hardware, software, firmware or combinations thereof for interfacing with various input/output components in device 800. I/O components may include devices such as keypads, buttons, audio devices, and sensors such as a global positioning system. I/O interfaces 811 process data for sending data to such I/O components or process data received from such I/O components.

Network interface 807 is enables data to be exchanged between devices device 800 and other devices via one or more networks (e.g., carrier or agent devices). For example, video or other image data may be received from other devices via network interface 807 and be stored in system memory 817 for subsequent processing (e.g., via a back-end interface to image signal processor 803) and display. The networks may include, but are not limited to, Local Area Networks (LANs) (e.g., an Ethernet or corporate network) and Wide Area Networks (WANs). The image data received via network interface 807 may undergo image processing processes by image signal processor 803.

Sensor interface 808 is circuitry for interfacing with motion sensor 819. Sensor interface 808 receives sensor information from motion sensor 819 and processes the sensor information to determine the orientation or movement of the device 800.

Display controller 809 is circuitry for sending image data to be displayed on display 810. Display controller 809 receives the image data from image signal processor 803, central processing unit 806, graphics processing unit 812 or system memory 817 and processes the image data into a format suitable for display on display 810.

Memory controller 813 is circuitry for communicating with system memory 817. Memory controller 813 may read data from system memory 817 for processing by image signal processor 803, central processing unit 806, graphics processing unit 812 or other subcomponents of system on a chip 802. Memory controller 813 may also write data to system memory 817 received from various subcomponents of system on a chip 802.

Video encoder 814 is hardware, software, firmware or a combination thereof for encoding video data into a format suitable for storing in persistent storage 816 or for passing the data to network interface 807 for transmission over a network to another device.

In some embodiments, one or more components of system on a chip 802 or some functionality of these components may be performed by software components executed on image signal processor 803, central processing unit 806, graphics processing unit 812. Such software components may be stored in system memory 817, persistent storage 816 or another device communicating with device 800 via network interface 807.

Image data or video data may flow through various data paths within system on a chip 802. In one example, raw image data may be generated from the image sensor 801 and processed by image signal processor 803, and then sent to system memory 817. After the image data is stored in system memory 817, it may be accessed by graphics processing unit 812, neural engine 820, and/or video encoder 814 for encoding or display 810.

In another example, image data is received from sources other than the image sensor 801. For example, video data may be streamed, downloaded, or otherwise communicated to the system on a chip 802 via wired or wireless network. The image data may be received via network interface 807 and written to system memory 817 via memory controller 813. The image data may then be obtained from system memory 817 and processed image signal processor 803, graphics processing unit 812, or neural engine 820. The image data may then be returned to system memory 817.

For clarity of explanation, in some instances, the present technology may be presented as including individual functional blocks including functional blocks comprising devices, device components, steps or methods in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a device and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per sc.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, strobe memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

### Aspects:

The present technology includes computer-readable storage mediums for storing instructions, and systems for executing any one of the methods embodied in the instructions addressed in the aspects of the present technology presented below:

Aspect 1. A method comprising: receiving, by a sketch-to-image conditioner, an outline of a graphical input, wherein the outline is a combination of a non-sketch portion of the graphical input and a sketch portion of the graphical input; receiving, by the sketch-to-image conditioner, the sketch portion of the graphical input separate from the non-sketch portion of the graphical input; receiving, by the sketch-to-image conditioner, a processed version of the non-sketch portion, wherein the processed version of the non-sketch portion of the graphical input is made to have characteristics of a sketch; causing a generative AI service to generate the stylized image that combines the non-sketch portion of the graphical input and the sketch portion of the graphical input as received from the sketch-to-image conditioner and as indicated in the outline of the graphical inputs into a consistent style output regardless of whether a portion of the output was inspired by the sketch portion of the graphical input or the non-sketch portion of the graphical input.

Aspect 2. The method of aspect 1, wherein the non-sketch portion is processed to have characteristics of a sketch by generating a low-resolution version of the non-sketch portion of the graphical input with modified color values, the modified color values being more consistent with color values present in a sketch made in a drawing application.

Aspect 3. The method of any one of aspects 1-2, further comprising: receiving a graphical style prompt that is descriptive of a desired style for the desired output; and selecting a graphical style adapter that is configured to adapt the generative AI service to output the stylized image in the desired style.

Aspect 4. The method of any one of aspects 1-3, further comprising: calculating a complexity metric for the sketch portion of the graphical input, receiving the complexity metric by the sketch-to-image conditioner, wherein the complexity metric indicates an importance of details included in the sketch portion of the graphical input, whereby the generative AI service generates the stylized image while using important details as prompt information to preserve characteristics of the details in the stylized image.

Aspect 5. The method of any one of aspects 1-4, further comprising: computing a shape mask from the sketch portion of the graphical input; and providing the shape mask into the sketch-to-image conditioner to guide a combination of the sketch portion of the graphical input with the non-sketch portion of the graphical input.

Aspect 6. The method of any one of aspects 1-5, wherein the computing the shape mask includes determining whether the sketch portion of the graphical input are an outline of an object that should include fill, and when it is determined that the object should include fill, computing the shape mask with filled portions.

Aspect 7. The method of any one of aspects 1-6, wherein the non-sketch portion of the graphical input is a photo.

Aspect 8. The method of any one of aspects 1-7, further comprising: providing output of the sketch-to-image conditioner, a text prompt describing a desired output that is based on the graphical input, and the graphical style prompt to a generative AI service.

Aspect 9. The method of any one of aspects 1-8, wherein the sketch-to-image conditioner is a neural network trained to provide inputs into the generative AI service, wherein the generative AI service is a general purpose prompt to image generative AI service, which is adapted to provide stylized images from sketches through conditioning from the sketch-to-image conditioner and the graphical style adapter.

Aspect 10. The method of any one of aspects 1-9, wherein the generative AI service is a diffusion model.

Aspect 11. The method of any one of aspects 1-10, wherein the consistent style output is selected from one of a sketch style, a realistic style, an animation style, or an illustration style.

Aspect 12. The method of any one of aspects 1-11, further comprising: replacing a portion of the stylized image that was generated in response to a prompt derived from the non-sketch portion of the graphical input with the original non-sketch portion of the graphical input using the shape mask to keep a second portion of the stylized image that was generated in response to a prompt derived from the sketch portion of the graphical input to result in an image including the second portion of the stylized image blended with the non-sketch portion of the graphical input, wherein the replacing the portion of the stylized image is in response a selected drawing over image mode configured to output a portion of the stylized image over the non-sketch portion of the graphical input.

Aspect 13. A method for receiving an input in a first style and providing an output in as a stylized image in a specified style, the method comprising: receiving at least one graphical input in a first style; receiving at least one graphical style prompt, wherein the graphical style prompt is for a stylized image in the specified style; condition the at least one graphical input in the first style into a prompt for a graphical style adapter of a generative AI service; receive the stylized image in the specified style requested by the graphical style prompt.

Aspect 14. The method of aspect 13, wherein the at least one graphical input in the first style is a sketch input.

Aspect 15. The method of any one of aspects 13-14, wherein the specified style is a sketch output style, whereby the stylized image is an improved sketch based on the graphical input.

Aspect 16. The method of any one of aspects 13-15, wherein the specified style is different than the first style, and the stylized image is in the specified style that is different than the first style.

Aspect 17. The method of any one of aspects 13-16, further comprising: receiving a text prompt describing a desired output that is based on the graphical input.

Aspect 18. A method comprising: receiving, by a sketch-to-image conditioner, an outline of a graphical input, wherein the outline is of a sketch portion of the graphical input; receiving, by the sketch-to-image conditioner, the sketch portion of the graphical input; causing a generative AI service to generate a stylized image based on the sketch portion of the graphical input as received from the sketch-to-image conditioner and as indicated in the outline of the graphical input into a consistent style output.

Aspect 19. The method of aspect 18, further comprising: receiving a graphical style prompt that is descriptive of a desired style for the desired output; and selecting a graphical style adapter that is configured to adapt the generative AI service to output the stylized image in the desired style.

Aspect 20. The method of any one of aspects 18-19, further comprising: calculating a complexity metric for the sketch portion of the graphical input, receiving the complexity metric by the sketch-to-image conditioner, wherein the complexity metric indicates an importance of details included in the sketch portion of the graphical input, whereby the generative AI service generates the stylized image while using important details as prompt information to preserve characteristics of the details in the stylized image.

Aspect 21. The method of any one of aspects 18-20, further comprising: receiving a text prompt describing a desired output that is based on the graphical input.

Aspect 22. The method of any one of aspects 18-21, further comprising: providing output of the sketch-to-image conditioner, the text prompt, and the graphical style prompt to a generative AI service.

Aspect 23. A system comprising at least one processor that is effective to cause the system to perform the method any one of aspects 1-22.

Aspect 24. A non-transitory computer-readable medium comprising a storage storing instructions, wherein the instructions are effective to cause at least one processor to perform the method of any one of aspects 1-22.

Other technical features may be readily apparent to one skilled in the art from the following figures, descriptions, and claims.

What is claimed is:

1. A method comprising:
receiving, by a sketch-to-image conditioner, an outline of a graphical input, wherein the outline is a combination of a non-sketch portion of the graphical input and a sketch portion of the graphical input;
receiving, by the sketch-to-image conditioner, the sketch portion of the graphical input separate from the non-sketch portion of the graphical input;
receiving, by the sketch-to-image conditioner, a processed version of the non-sketch portion, wherein the processed version of the non-sketch portion of the graphical input is made to have characteristics of a sketch;
causing a generative AI service to generate a stylized image that combines the non-sketch portion of the graphical input and the sketch portion of the graphical input as received from the sketch-to-image conditioner and as indicated in the outline of the graphical input into a consistent style output regardless of whether a portion of the consistent style output was inspired by the sketch portion of the graphical input or the non-sketch portion of the graphical input.

2. The method of claim 1, wherein the non-sketch portion is processed to have the characteristics of the sketch by generating a low-resolution version of the non-sketch portion of the graphical input with modified color values, the modified color values being more consistent with color values present in a sketch made in a drawing application.

3. The method of claim 1, further comprising:
receiving a graphical style prompt that is descriptive of a desired style for a desired output; and
selecting a graphical style adapter that is configured to adapt the generative AI service to output the stylized image in the desired style.

4. The method of claim 1, further comprising:
calculating a complexity metric for the sketch portion of the graphical input,
receiving the complexity metric by the sketch-to-image conditioner, wherein the complexity metric indicates an importance of details included in the sketch portion of the graphical input, whereby the generative AI service generates the stylized image while using important details as prompt information to preserve characteristics of the details in the stylized image.

5. The method of claim 1, further comprising:
computing a shape mask from the sketch portion of the graphical input; and
providing the shape mask into the sketch-to-image conditioner to guide the combination of the sketch portion of the graphical input with the non-sketch portion of the graphical input.

6. The method of claim 5, wherein computing the shape mask includes determining whether the sketch portion of the graphical input are an outline of an object that should include fill, and when it is determined that the object should include fill, computing the shape mask with filled portions.

7. The method of claim 2, wherein the non-sketch portion of the graphical input is a photo.

8. The method of claim 1, further comprising:
providing output of the sketch-to-image conditioner, a text prompt describing a desired output that is based on the graphical input, and a graphical style prompt to the generative AI service.

9. The method of claim 1, wherein the sketch-to-image conditioner is a neural network trained to provide inputs into the generative AI service, wherein the generative AI service is an image generative AI service which is adapted to provide stylized images from sketches through conditioning from the sketch-to-image conditioner and a graphical style adapter.

10. The method of claim 1, wherein the generative AI service is a diffusion model.

11. The method of claim 1, wherein the consistent style output is selected from one of a sketch style, a realistic style, an animation style, or an illustration style.

12. The method of claim 1, further comprising:
replacing a portion of the stylized image that was generated in response to a prompt derived from the non-sketch portion of the graphical input with the non-sketch portion of the graphical input using a shape mask to keep a second portion of the stylized image that was generated in response to a prompt derived from the sketch portion of the graphical input to result in an image including the second portion of the stylized image blended with the non-sketch portion of the graphical input, wherein the replacing the portion of the stylized image is in response a selected drawing over image mode configured to output a portion of the stylized image over the non-sketch portion of the graphical input.

13. A method comprising:
receiving at least one graphical input in a first style;
receiving at least one graphical style prompt, wherein the at least one graphical style prompt is for a stylized image in a specified style;
condition the at least one graphical input in the first style into a prompt for a graphical style adapter of a generative AI service;
receive the stylized image in the specified style requested by the at least one graphical style prompt.

14. The method of claim 13, wherein the at least one graphical input in the first style is a sketch input.

15. The method of claim 14, wherein the specified style is a sketch output style, whereby the stylized image is an improved sketch based on the at least one graphical input.

16. The method of claim 13, wherein the specified style is different than the first style, and the stylized image is in the specified style that is different than the first style.

17. The method of claim 13, further comprising:
receiving a text prompt describing a desired output that is based on the at least one graphical input.

18. A method comprising:
receiving, by a sketch-to-image conditioner, an outline of a graphical input, wherein the outline is of a sketch portion of the graphical input;
receiving, by the sketch-to-image conditioner, the sketch portion of the graphical input;
causing a generative AI service to generate a stylized image based on the sketch portion of the graphical input as received from the sketch-to-image conditioner and as indicated in the outline of the graphical input into a consistent style output.

19. The method of claim 18, further comprising:
receiving a graphical style prompt that is descriptive of a desired style for a desired output; and
selecting a graphical style adapter that is configured to adapt the generative AI service to output the stylized image in the desired style.

20. The method of claim 18, further comprising:
calculating a complexity metric for the sketch portion of the graphical input,
receiving the complexity metric by the sketch-to-image conditioner, wherein the complexity metric indicates an importance of details included in the sketch portion of the graphical input, whereby the generative AI service generates the stylized image while using important details as prompt information to preserve characteristics of the details in the stylized image.

21. The method of claim 18, further comprising:
receiving a text prompt describing a desired output that is based on the graphical input.

22. The method of claim 21, further comprising:
providing output of the sketch-to-image conditioner, the text prompt, and a graphical style prompt to the generative AI service.
